(19) United States
(12) Patent Application Publication
(10) Pub. No.: US 2008/0098366 A1
(43) Pub. Date: Apr. 24, 2008

(54) Assertion Tester

(75) Inventors: David Fong, San Jose, CA (US); Stanley John, Fremont, CA (US); Zheng (Joy) Zhang, Shanghai (CN); Qi (Christine) Chen, Shanghai (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Hsin-Tien (TW)

(21) Appl. No.: 11/539,663

(22) Filed: Oct. 9, 2006

(51) Int. Cl. G06F 9/44; G06F 9/45

(52) U.S. Cl. 717/135; 717/143

(57) ABSTRACT

Included is a method for testing an assertion written for a logic program that can be simulated in a simulation program. Embodiments of the method include receiving the assertion independent from the logic program and independent from the simulation program, wherein the assertion includes at least one variable from the simulation program and determining the at least one variable in the assertion. Embodiments of the method also include testing the assertion independent from the logic program and the simulation program, wherein testing the assertion includes testing the assertion with at least one value for the at least one variable and determining at least one violation of the assertion.

### BACKGROUND

In the field of microchip design, chip designers and programmers can write complex algorithms to represent desired logic. Depending on the particular project and the particular chip designer, the algorithm can be written in any of a plurality of programming languages, including but not limited to Very High Speed Integrated Circuit Hardware Description Language (abbreviated as VHSIC-HDL or VHDL), Verilog, C++, etc. Additionally, as the algorithms become more complex, the chip designer or programmer can implement various techniques to ensure the accuracy of the algorithm. Oftentimes, the chip designer can include comments into the program, such that when debugging or improving the algorithm, the chip designer can more clearly understand the workings of the algorithm without having to simulate or synthesize the algorithm.

Another technique that programmers and chip designers use for ensuring the accuracy of an algorithm is an assertion function inserted within the program itself. While some programming and hardware description languages (HDLs) include an assertion function within their libraries, there are other, more specific assertion programs that can operate as part of the simulation program (computer, synthesizer, etc.) to more concisely and easily perform assertions within the programming languages. More specifically System Verilog Assertion (SVA), Property Specification Language (PSL) and Open Vera Assertion (OVA) can be used as part of an HDL to provide a more comprehensive assertion function.

While these programs can assist the programmer or chip designer in developing the desired logic and ensuring its accuracy, there can be problems in current techniques. More specifically, as the complexity of algorithms (and thus the logic program that describes the logic) increases, assertions can become more valuable. However, as the algorithms become more complex and the number of inputs and other variables increases, the assertions become more difficult to implement. Depending on the particular programming language and configuration, the programmer or chip designer may desire to individually determine the value for each input. Additionally, there may not be a simple way for the programmer to test internal variables within the algorithm to determine if an assertion is operating as desired. More specifically, when a programmer or chip designer creates a program that includes assertion, the programmer or chip designer generally will manually determine each value for each input and will run a simulation. From the values generated in the simulation, the programmer or chip designer can determine whether the program is operating properly, and whether the assertion is operating properly. One problem that programmers encounter is that there may not be a way to easily determine whether the assertion is operating properly, and thus whether the program is operating properly.

Thus, a heretofore unaddressed need exists in the industry to address the aforementioned deficiencies and inadequacies.

### SUMMARY

Included in this disclosure are embodiments of an assertion program for testing an assertion that is written for a logic program. At least one embodiment of the assertion program includes logic configured to determine at least one variable in the assertion and logic configured to determine values for the at least one variable in the assertion. Other embodiments include logic configured to determine at least one of value of the variable that corresponds to a violation of the assertion and logic configured to display at least one determined value related to the violation of the assertion.

Also included herein are embodiments of a method for testing an assertion written for a logic program that can be simulated in a simulation program. Embodiments of the method include receiving the assertion independent from the logic program and independent from the simulation program, where the assertion includes at least one variable from the simulation program. Embodiments of the method also include determining the at least one variable in the assertion. The assertion is tested, independent from the logic program and the simulation program. Testing the assertion, in this nonlimiting example, includes testing the assertion with at least one value for the at least one variable and determining at least one violation of the assertion.

Also included herein are embodiments of a computer readable medium that includes an assertion program for testing an assertion written for a logic program, where the logic program can be executed in a simulation program, where the assertion program is different than the simulation program, and where the assertion program is different than the logic program. Embodiments of the assertion program include logic configured to receive the assertion independent from the logic program and independent from the simulation program, wherein the assertion includes at least one variable from the logic program and logic configured to determine the at least one variable in the assertion. Embodiments of the assertion program also include logic configured to test the assertion independent from the logic program, wherein testing the assertion includes testing the assertion with at least one value for the at least one variable and logic configured to determine at least one violation of the assertion from the testing of the assertion.

Other systems, methods, features, and advantages of this disclosure will be or become apparent to one with skill in the art upon examination of the following drawings and detailed description. It is intended that all such additional systems, methods, features, and advantages be included within this description, be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

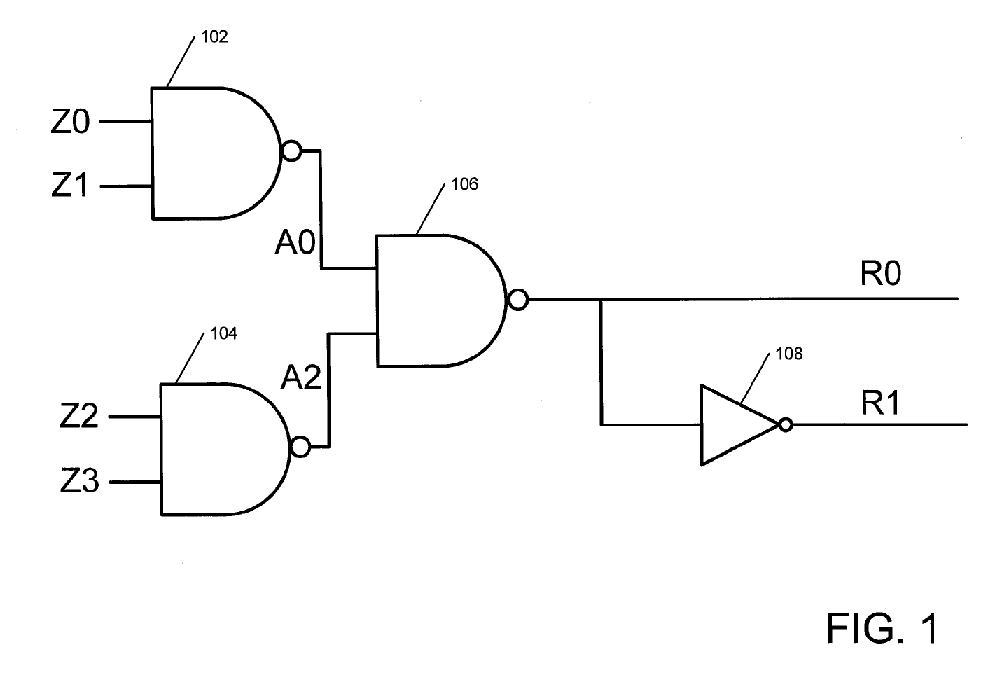

FIG. 1 is a functional diagram illustrating exemplary digital logic that can be implemented using a programming language.

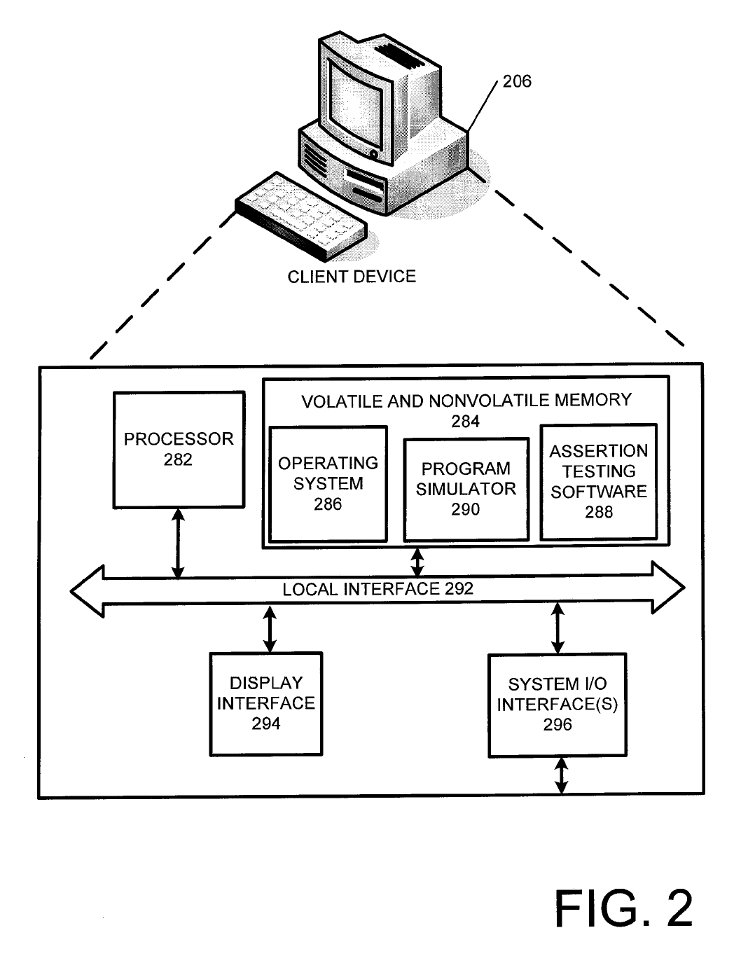

FIG. 2 is a functional diagram illustrating exemplary components of a client device that may include a programming language that can describe the logic from FIG. 1.

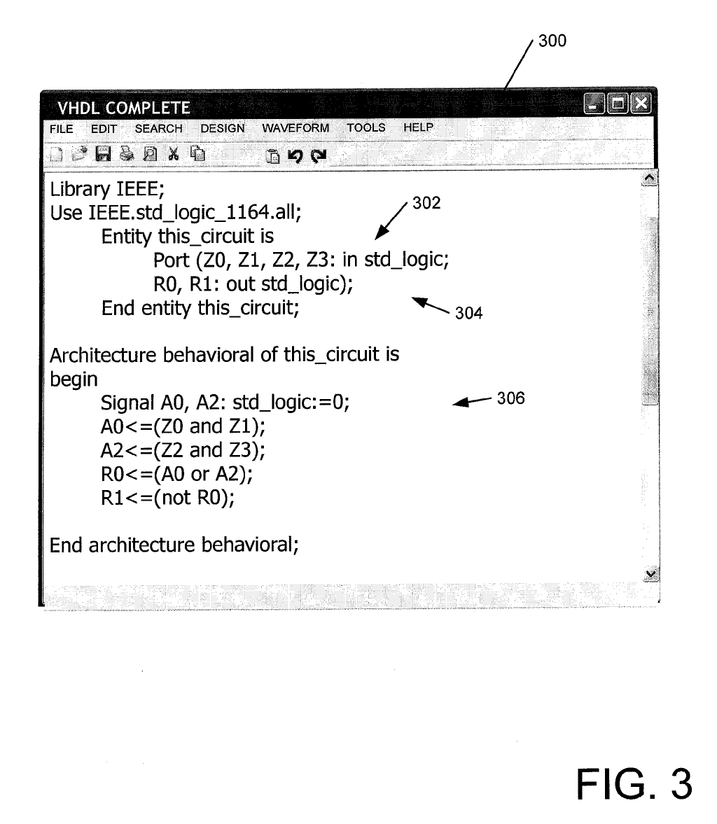

FIG. 3 is a screenshot of an exemplary VHDL program that can be used to implement the logic from FIG. 1.

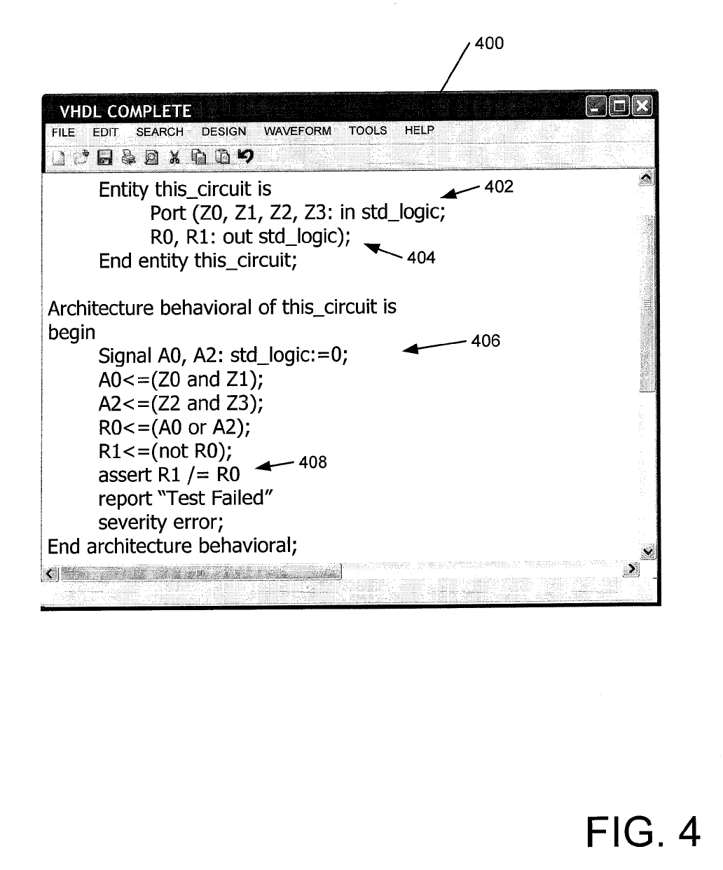

FIG. 4 is a screenshot of an exemplary VHDL program with an assertion that can be used to determine whether the VHDL program is an accurate representation of the logic from FIG. 1.

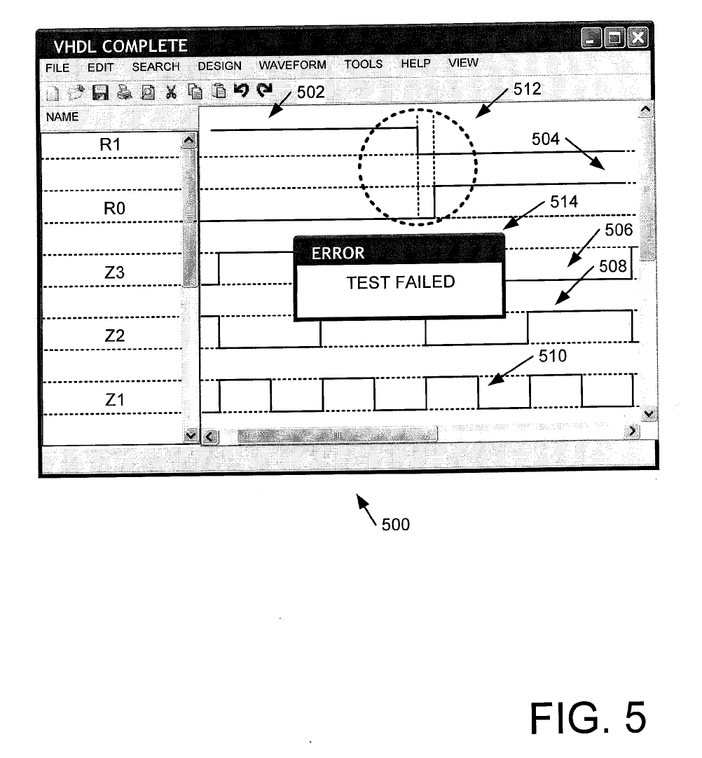

FIG. 5 is a screenshot of an exemplary test sequence of the program from FIG. 4.

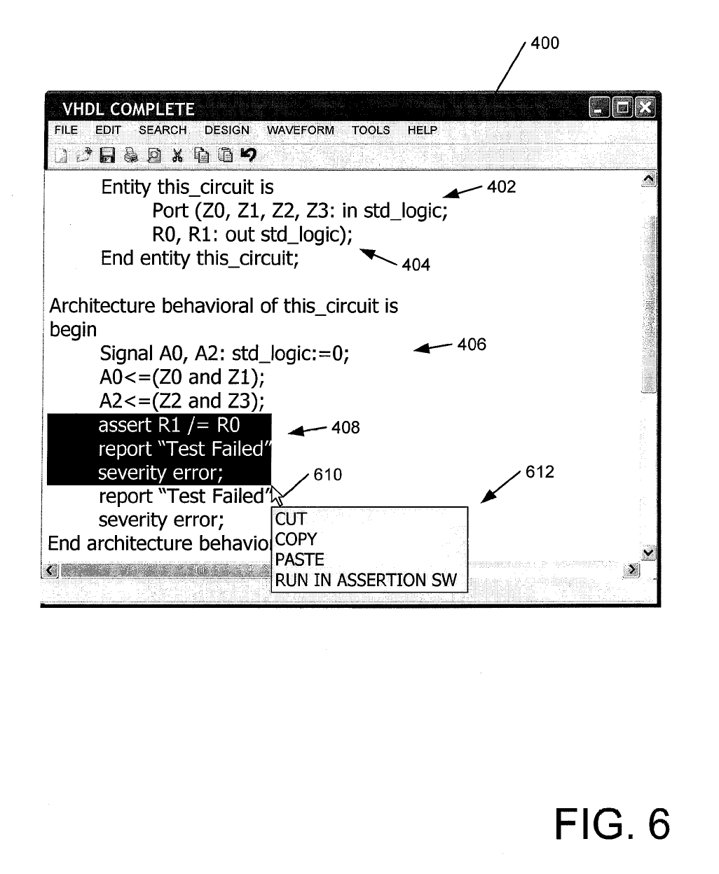

FIG. 6 is a screenshot of an exemplary technique for testing the assertion from FIG. 4.

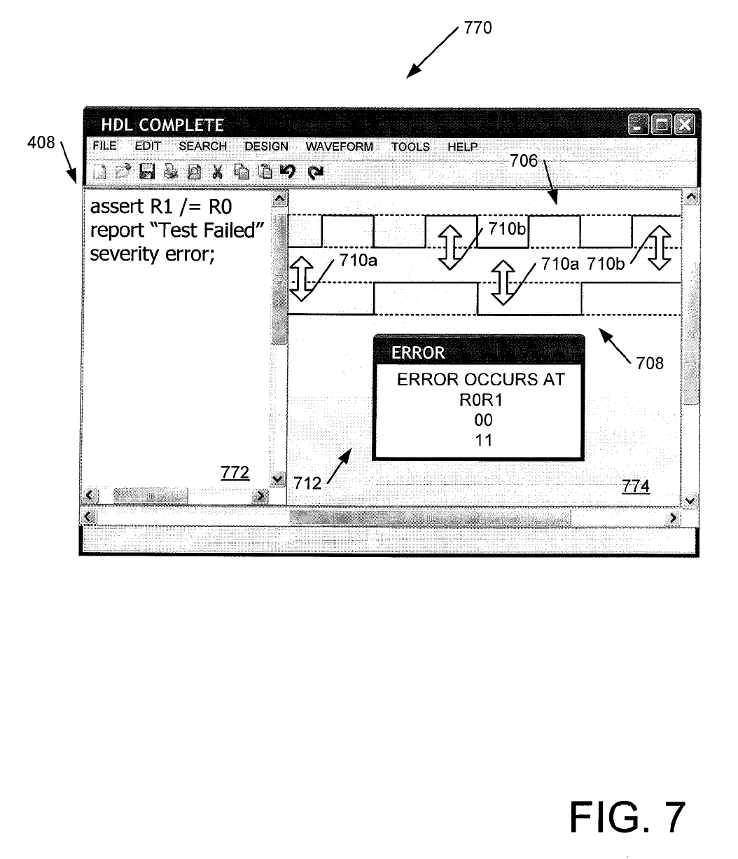

FIG. 7 is a screenshot of exemplary logic for determining the operation of the assertion from FIG. 4.

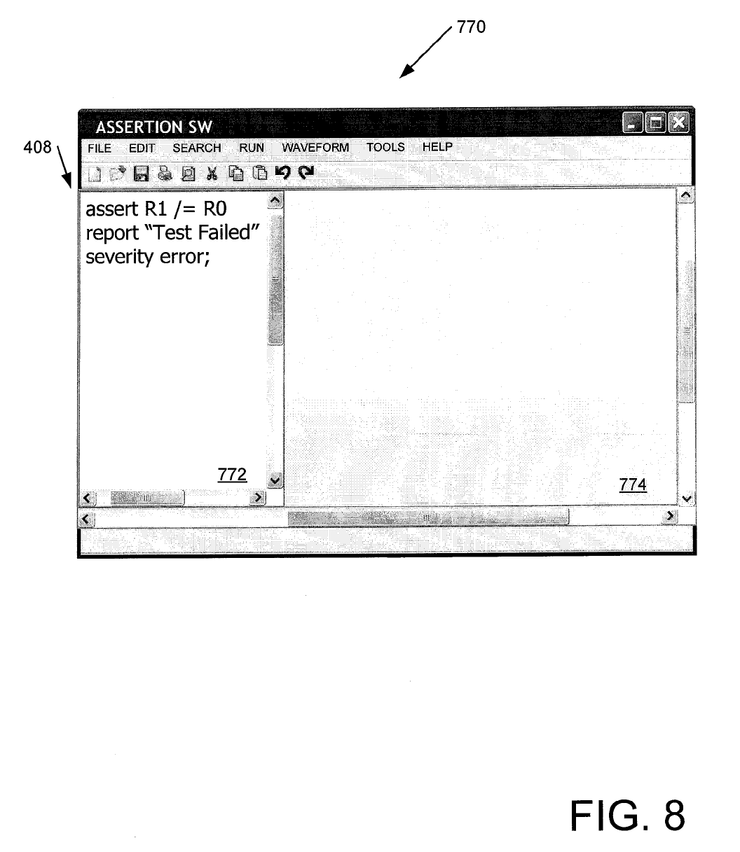

FIG. 8 is a screenshot of exemplary logic for manually testing an assertion that can be inserted into the VHDL program from FIG. 4.

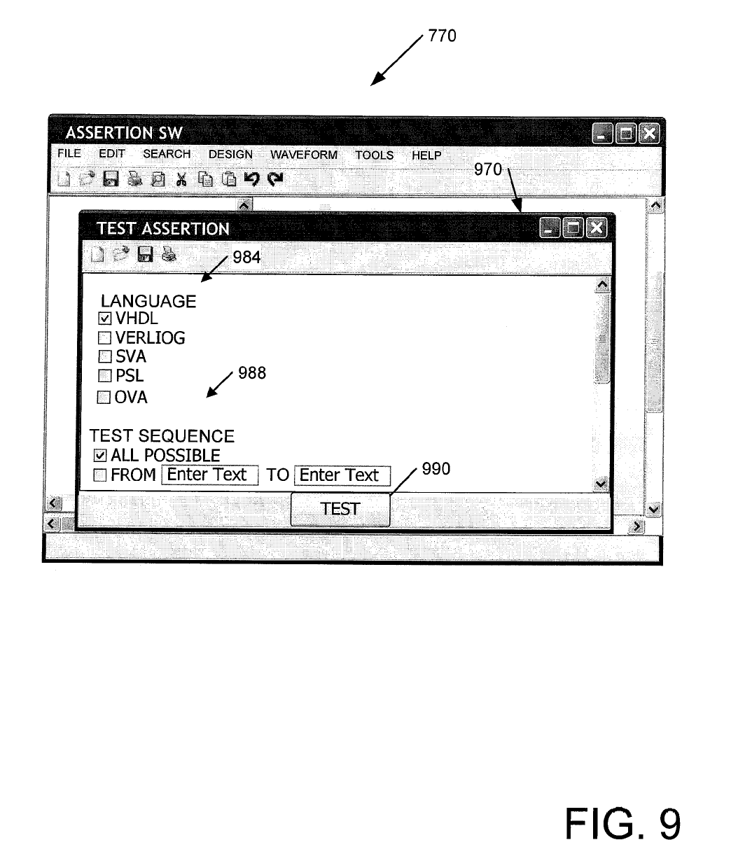

FIG. 9 is a screenshot of an exemplary display for determining various options for testing the assertion from FIG. 8.

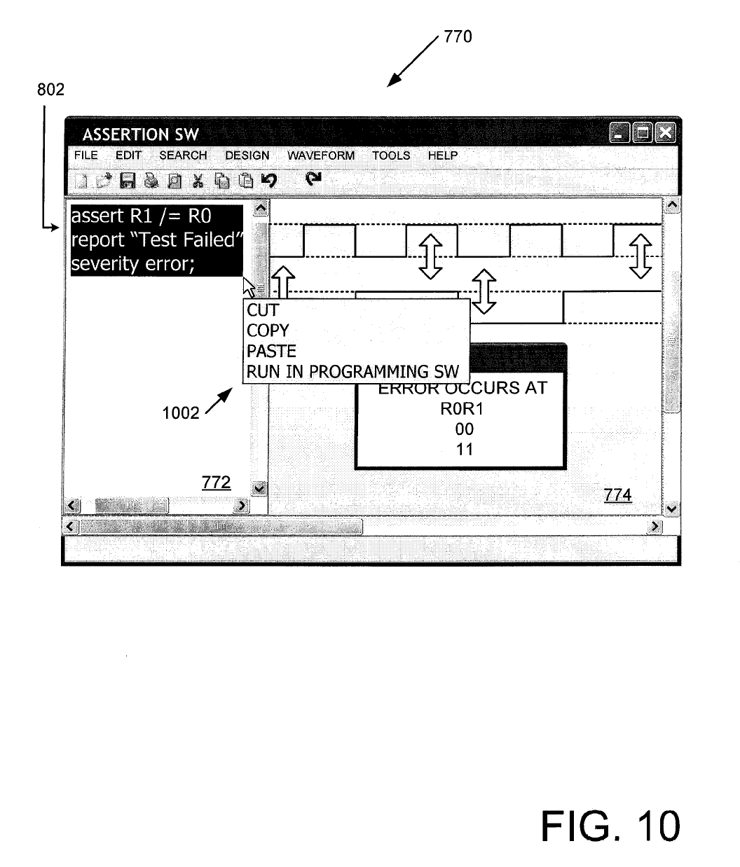

FIG. 10 is a screenshot of an exemplary test sequence for testing the assertion from FIG. 8.

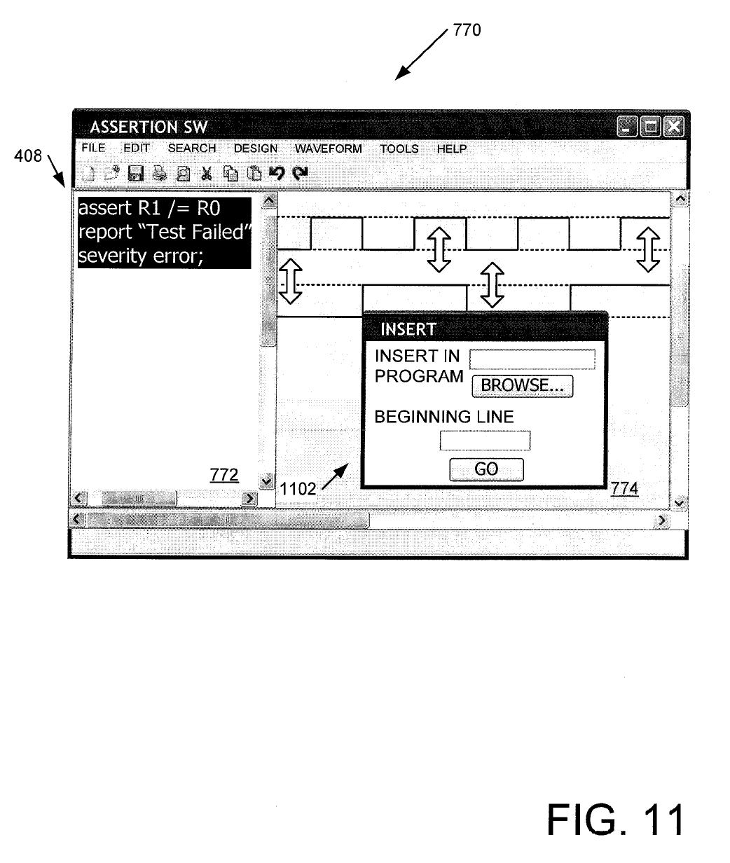

FIG. 11 is a screenshot of an exemplary display for inserting the assertion from FIG. 8 into a program.

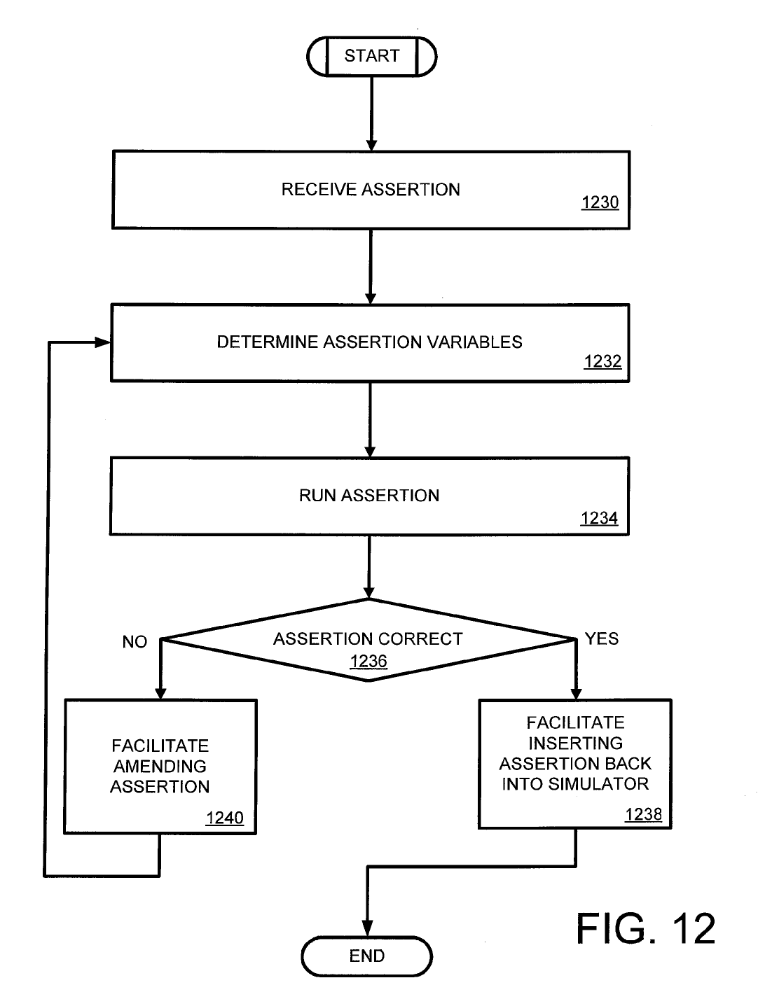

FIG. 12 is a flowchart illustrating exemplary steps that can be taken for testing the assertion from FIG. 4.

### DETAILED DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

FIG. 1 is a functional diagram illustrating exemplary digital logic that can be implemented using a programming language. More specifically, the logic in FIG. 1 includes three “NAND” gates 102, 104, 106 and a “NOT” gate 108. Inputs Z0 and Z1 are input into NAND gate 102 and inputs Z2 and Z3 are input into NAND gate 104. These gates produce the internal signals A0 and A2, which can be input into NAND gate 106. NAND gate 106 can then produce output R0. R0 can also be input into NOT gate 108 to produce output signal R1.

One should note that while the above described logic can be implemented using NAND gates, the same results can be obtained using different gates, such as “AND” gates and “OR” gates, or by using a computer programming language, such as an HDL. Additionally, while the logic described herein with respect to FIG. 1 illustrates single bit inputs and outputs, this is also a nonlimiting example. Any kind of logic with any of a plurality of different types of inputs and outputs can be implemented for purposes of this discussion.

FIG. 2 is a functional diagram illustrating exemplary components of a client device that may include a programming language that can describe the logic from FIG. 1. More specifically, client device 206 can take the form of a personal computer (PC), a mobile or cellular telephone) a personal digital assistant (PDA), or other device capable of executing logic. Generally, in terms of hardware architecture, as shown in FIG. 2, the client device 206 includes a processor 282, volatile and nonvolatile memory 284, and one or more input and/or output (I/O) device interface(s) 296 that are communicatively coupled via a local interface 292. The local interface 292 can be, for example but not limited to, one or more buses or other wired or wireless connections. The local interface 292 may have additional elements, which are omitted for simplicity, such as controllers, buffers (caches), drivers, repeaters, and receivers to enable communications. Further, the local interface 292 may include address, control, and/or data connections to enable appropriate communications among the aforementioned components. The processor 282 is a hardware device for executing software, particularly software stored in volatile and nonvolatile memory 284.

The processor 282 can be any custom made or commercially available processor, a central processing unit (CPU), an auxiliary processor among several processors associated with the client device 206, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard® Company, an 80x86 or Pentium® series microprocessor from Intel® Corporation, a PowerPC® microprocessor from IBM®, a Sparc® microprocessor from Sun Microsystems®, Inc, or a 68xxx series microprocessor from Motorola® Corporation.

The volatile and nonvolatile memory 284 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 214 can incorporate electronic, magnetic, optical, and/or other types of storage media. Note that the volatile and nonvolatile memory 284 can have a distributed architecture, where various components are situated remotely from one another, but can be accessed by the processor 282.

The software in volatile and nonvolatile memory 284 may include one or more separate programs, each of which includes an ordered listing of executable instructions for implementing logical functions. In the nonlimiting example of FIG. 2, the software in the volatile and nonvolatile memory 284 may include assertion testing software 288 and a program simulator (or compiler) 290, as well as an operating system 286. A nonexhaustive list of examples of suitable commercially available operating systems is as follows: (a) a Windows® operating system available from Microsoft® Corporation; (b) a Netware® operating system available from Novell®, Inc.; (c) a Macintosh® operating system available from Apple® Computer, Inc.; (d) a UNIX operating system, which is available for purchase from many vendors, such as the Hewlett-Packard® Company, Sun Microsystems®, Inc., and AT&T® Corporation; (e) a LINUX operating system, which is freeware that is readily available on the Internet; (f) a run time Vxworks® operating system from WindRiver® Systems, Inc.; or (g) an appliance-based operating system, such as that implemented in handheld computers or personal data assistants (PDAs) (e.g., PalmOS® available from Palm® Computing, Inc., and Windows CE® available from Microsoft® Corporation). The operating system essentially controls the execution of other computer programs and provides scheduling, input-output control, file and data management, memory management, and communication control and related services.

A system component embodied as software may also be construed as a source program, executable program (object code), script, or any other entity comprising a set of instructions to be performed. When constructed as a source program, the program is translated via a compiler, assembler, interpreter, or the like, which may or may not be included within the volatile and nonvolatile memory 284, so as to operate properly in connection with the Operating System 286.

Input/Output devices that may be coupled to system I/O Interface(s) 296 may include input devices, for example but not limited to, a keyboard, mouse, scanner, microphone, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

If the client device 206 is a Personal Computer, workstation, or the like, the software in the volatile and nonvolatile memory 284 may further include a basic input output system (BIOS) (omitted for simplicity). The BIOS is a set of essential software routines that initialize and test hardware at startup, start the Operating System, and support the transfer of data among the hardware devices. The BIOS can be stored in ROM so that the BIOS can be executed when the client device 206 is activated.

When the client device 206 is in operation, the processor 282 is configured to execute software stored within the volatile and nonvolatile memory 284, to communicate data to and from the volatile and nonvolatile memory 284, and to generally control operations of the client device 206 pursuant to the software. Software in memory, in whole or in part, can be read by the processor 282, perhaps buffered within the processor 282, and then executed.

One should note that while the above description with respect to FIG. 2 refers to components of a client device 206, some or all of these components may also be present in a server, to which the client device 206 is coupled. More specifically, while the assertion testing software 288 (and programming language software) can be located in volatile and nonvolatile memory 284 of client device 206, in some embodiments assertion testing software 288 can be located externally of client device log. Thus the components described with reference to FIG. 2 can be applied to a client device 206, a server, other device, or any permutation of these, depending on the desired configuration.

FIG. 3 is a screenshot of an exemplary VHDL program that can be used to implement logic from FIG. 1. More specifically, the display window 300 can be associated with a VHDL simulation program. As such, the display window 300 can be configured to facilitate creation and display of a VHDL program. More specifically, the VHDL simulation program of FIG. 3 includes a logic program for describing a piece of logic. The logic program includes inputs Z0, Z1, Z2, and Z3 at 302, and outputs R0 and R1 at 304. Additionally included in the VHDL logic program of FIG. 3 is an indication of internal signals A0 and A2 at 306. One should note that while the inputs 302, outputs 304, and internal signals 306 are defined as standard logic, this is a nonlimiting example, as any type of data can be provided for the inputs, outputs and internal signals.

Also included in the log program of FIG. 3 is an assignment of Z0 AND Z1 as internal signal A0. More specifically, referring back to FIG. 1, the inputs Z0 and Z1 can be input into NAND gate 102. While FIG. 1 discusses logic with NAND gates, the use of logical AND and logical OR can be substituted for the NAND gates of FIG. 1. As also illustrated in FIG. 3, the internal signal A2 is assigned a value equal to the logical expression (Z2 AND Z3). The output R0 is defined as being equal to the logical expression of internal signals (A0 OR A2). The output R1 is defined as being the logical NOT of R0.

FIG. 4 is a screenshot if an exemplary VHDL simulator program with an assertion that can be used to determine whether the VHDL logic program is an accurate representation of the logic from FIG. 1. Similar to the VHDL logic program from FIG. 3, this VHDL logic program includes inputs Z0, Z1, Z2, and Z3, shown as element 402. Additionally, element 404 introduces the outputs R0 and R1. Element 406 introduces internal signals A0 and A2. Similar to the VHDL logic program from FIG. 3, the internal signal A0 is assigned a value equal to (Z0 AND Z1). Internal signal A2 is assigned a value equal to (Z2 AND Z3). R0 is assigned a value equal to (A0 OR A2). R1 is assigned a value equal to (NOT R0).

Additionally included in this nonlimiting example is an assertion 408. The assertion 408 states that R1 should always equal (NOT R0). If R1 is not equal to (NOT R0) then the assertion will report “Test Failed” and the severity of this violation will be an error. Assertions like this can be used as a programming tool to determine whether a program is operating properly. More specifically, by using an assertion the programmer can determine whether the logic program variables are operating correctly. As R0 should always equal (NOT R1), the programmer will know there is a problem if the assertion is violated.

Assertions can be used to determine if or when illegal operations occur in a program. Additionally, while the assertion 408 indicates a violation with respect to outputs, assertions can be used to determine errors in any of the variables of the program. When the program of FIG. 4 is simulated, the programmer can determine various inputs for the simulation and simulate the outputs according to the inputs provided. While the assertion can provide the programmer with an indication as to whether the assertion is violated, the programmer may not have a way to determine whether the assertion is written properly. More specifically, if the programmer accidentally included a typographical or other error in the assertion, the programmer may be provided with incorrect information related to the operation of the program. Additionally, because the programmer has limited resources in determining whether the assertion is operating correctly, the programmer may have limited resources in determining whether the program is operating correctly.

FIG. 5 is a screenshot of an exemplary test sequence of the logic program from FIG. 4. As illustrated in display window 500, the inputs Z3, Z2, Z1, and Z0 (Z0 not shown) are associated with a plurality of logical values, as shown with waveforms 506, 508, and 510, respectively. Additionally, outputs R0 and R1 are displayed with their values that correspond to the displayed inputs. More specifically, R1 and R0 are associated with waveforms 502 and 504 respectively. Additionally, as displayed with dotted circle 512 and corresponding dotted vertical lines, there is a portion of the waveforms associated with R1 and R0 that violates the assertion of FIG. 4. More specifically, as shown in circle 512, there is a time when R1=R0=0. The assertion from FIG. 4 states that R1 must be equal to (NOT R0), so when R1 equals R0, error window 514 is displayed with the text “Test Failed.”

As stated above, the display of a violation of the assertion can be beneficial to a programmer for determining whether the program is operating correctly, and if not, where an error occurs. However, as also described above, the use of assertions can be deterred by the inability of the programmer to determine whether the assertion is operating properly. More specifically, when an assertion incorporates a plurality of variables and a plurality of operations, the likelihood of error with respect to the assertion logic can be jeopardized. Additionally, as the complexity of the insertion increases, the likelihood of an error in inputting the assertion can also increase.

FIG. 6 is a screenshot of an exemplary technique for testing the assertion from FIG. 4. More specifically, as illustrated in FIG. 4, display window 400 for an exemplary simulator program includes inputs Z0, Z1, Z2, and Z3 at element 402. Outputs R0 and R1 are indicated at element 404. A logic program with internal signals A0 and A2 are indicated at element 406. Assertion 408 is indicated as in FIG. 4, except that in this nonlimiting example, the programmer can highlight the text of the assertion with the mouse cursor 610. Additionally, by “right clicking” on the highlighted text, the programmer can facilitate display of options box 612, which can include one or more options that may include “copy,” “cut,” “paste,” and “run in assertion software.” The “copy” option can provide the programmer with the ability to copy the highlighted text to a virtual notepad for insertion at a different locale, without disturbing the highlighted text. The “cut” option can provide the programmer with the ability to cut the highlighted text from its current location for insertion at a different location. The paste option can provide the programmer with the ability to insert the cut or copied text at a position of the programmer's choice.

Additionally included in the options box 610 is a “run in assertion software” option. The “run in assertion software” option can provide the programmer with the ability to automatically copy and execute the highlighted assertion in an assertion testing software. More specifically, if the programmer does not know whether the assertion is correctly written, the programmer can highlight the desired assertion and choose the “run in assertion software” option. The assertion can then be copied from its current location and inserted into an assertion testing software. The assertion testing software can then execute the assertion to provide the programmer with information related to the operation of the assertion.

FIG. 7 is a screenshot of exemplary logic for determining the operation of the assertion from FIG. 4. As illustrated in the display window 770, the assertion software can be configured to display a text window 772 and a graphical window 774. In the text window 772 the assertion can be displayed. The assertion 408 can be manually entered into the text window 772 (as discussed below), or the assertion software can retrieve the assertion via the programmer selecting the “run in assertion software” option from FIG. 6 (or via other techniques). In some embodiments the assertion software can be linked with the simulator software, compiler, and/or other programming software (in this disclosure the term “simulator software”, “simulator program”, and “simulator logic” can be construed to include simulators, synthesizers, computers, or any permutation thereof), depending on the configuration such that when the simulator software is opened, the assertion software can also be opened to a state that permits communication of data between the assertion program. When the programmer selects the “run in assertion software” option from FIG. 6, the assertion software can be configured to receive the assertion in text window 772. Additionally, upon selecting this option, the assertion software can be configured to execute the assertion for all possible scenarios associated with the variables included in the assertion. This information can be displayed in a graphical representation with indicators that denote when the assertion is violated. As illustrated in graphical window 774, the waveform 706 can represent R0 and the waveform 708 can represent R1. The violation indicators 710a denote that there is a violation when R0=R1=0. Violation indicators 710b denote that there is a violation in the assertion when R0=R1=1. Additionally, included in the graphical window 774 is an error window 712, that can indicate to the programmer the values at which the assertion is violated (in this nonlimiting example when R0R1=00 and 11).

One should also note that while the depiction of display window 770 includes a graphical representation of the assertion data, this is a nonlimiting example. While some embodiments can include a graphical display of the data, other embodiments can provide the programmer with the desired assertion data in other manners as well.

Additionally, while the nonlimiting example described above indicates that the assertion software can be configured to run the assertion for all possible permutations of the variables included in the assertion, this is also not a requirement. In at least one embodiment the assertion software can include logic that is configured to provide the programmer with the ability to determine the variables and values of those variables that the programmer desires tested.

FIG. 8 is a screenshot of exemplary logic for manually testing an assertion that can be inserted into the VHDL logic program from FIG. 4. Included in this nonlimiting example is display window 770, which includes text window 772 and graphical window 774. As discussed above, text window can be configured to provide the programmer with the ability to manually enter an assertion, without the use of the simulator or compiler. Additionally, the assertion software can be configured to provide a programmer with the ability to modify assertions that are input in the text window 772 (either manually or via the “run in assertion software” option, discussed above). Once the programmer has entered or amended the assertion to his or her specifications, the programmer can select a “run” option, which can be located on the menu toolbar of display window 770.

FIG. 9 is a screenshot of an exemplary display for determining various options for testing the assertion from FIG. 8. In this nonlimiting example, the programmer has selected an option, such as the “run” option. In response to this programmer selection, the assertion software can be configured to provide display window 970 that can provide the programmer with supplemental options related to the entered assertion.

More specifically, the programmer can be provided with a “language” option 984, which can allow the programmer to select the programming language of the assertion. While some embodiments can be configured to automatically determine the programming language of the assertion, other embodiments can be configured to provide the programmer with the ability to determine the programming language.

Additionally included the display window 970 is a “test sequence” option 988. The “test sequence” option 988 can be configured to allow the programmer to determine whether the assertion software tests all possible permutations of the variables, or whether the user decides the values to be tested.

While the second option of the “test sequence” option 988 illustrates the ability for the programmer to provide a range of values, this is a nonlimiting example. Other embodiments can include providing the programmer with the ability to individually select the values to be tested. When the programmer has selected the desired options, the programmer can select the “test” option 990, to run the assertion test.

One should also note that although the language option 984 and the test sequence option 988 are illustrated, other options can also be provided. More specifically, other embodiments can include options to more fully customize the assertion for implementation in the desired program.

FIG. 10 is a screenshot of an exemplary test sequence for testing the assertion from FIG. 8. As illustrated, the assertion has been run and the assertion software is displaying violations in the assertion. Additionally, in at least one embodiment, the programmer can insert the assertion into a simulator by first highlighting the assertion 408 and “right clicking” the highlighted text. Upon “right clicking” the highlighted assertion, an options window 1002 may be displayed to provide the user with various options including “cut,” “copy,” “paste,” and “run in programming software.” As discussed above with respect to FIG. 6, the user can select the “cut” and “paste options” and/or the “copy” and “paste” options for inserting the assertion into the programming software. Additionally, by selecting the “run in programming software” option, the assertion software can automatically copy highlighted text for insertion into a program, as discussed with respect to FIG. 11.

FIG. 11 is a screenshot of an exemplary display for inserting the assertion from FIG. 8 into a program. As illustrated in FIG. 10, the programmer can select a “run in programming software” option. In response to selecting this option, the assertion software can display the insert window 1102 for providing the desired location of the assertion. The insert window 1102 can include a file path prompt for providing the destination (or destinations) for the assertion. As also illustrated, the programmer can select the line number that the programmer wishes to insert the assertion.

Additionally, while not illustrated in FIG. 11, the assertion software can also be configured to provide the ability to open a program for the programmer to select the desired location for inserting the assertion. More specifically, a programmer may not know the exact line number or file path of the program that the programmer wants to access. In such a scenario, the programmer can open the desired program and select the line that the programmer wants to insert the assertion. Additionally, other techniques can also be implemented for sending an assertion from the assertion software to the simulator and/or compiler (or other program).

One should note that in at least one embodiment, the assertion software can be configured to prompt the user for the desired outputs of the assertion. Upon receiving the desired outputs and executing the assertion, the assertion software may then compare the actual outputs of the assertion with the desired outputs of the assertions to determine whether the assertion is operating properly. Other techniques for determining the operation of an assertion are also contemplated.

FIG. 12 is a flowchart illustrating exemplary steps that can be taken for testing the assertion from FIG. 4. As illustrated, the first step in the flowchart of FIG. 12 is to receive an assertion (block 1230). The assertion can be received from a simulator, compiler, etc, however this is not a requirement. As discussed above, at least one embodiment can include receiving the assertion via direct user input. Regardless of the source of the assertion, the assertion software can determine the assertion variables (block 1232). As the assertion can implement one or more variable, the assertion software can be configured to automatically determine the variables that are to be tested. Additionally, some embodiments can be configured to receive user input regarding the variables and values of those variables to test.

The next step in the flowchart of FIG. 12 is to run the assertion (block 1234). As stated above, the assertion can automatically run (and/or be tested) when the assertion is received at the assertion software. Other embodiments can provide for the programmer to determine when the assertion software is run. Once the assertion is run, a determination of whether the assertion is correct can be performed (block 1236). The programmer can perform the determination, however this is not a requirement. In some embodiments the assertion software 408 can be configured to receive data related to the desired violations, in addition to the assertion 408. The assertion software can then compare the assertion 408 with the desired violations to determine whether the assertion is written correctly.

If the assertion 408 is not correct, the assertion software can facilitate amending the assertion 408 (block 1240). In at least one embodiment, the assertion software can facilitate amending the assertion 408 by providing an option for the programmer to change assertion 408. Once the assertion has been amended, the flowchart returns to block 1232 to determine the assertion variables. From this point, the flowchart proceeds as before. If, on the other hand, the assertion is correct (at block 1236), the flowchart can facilitate inserting the assertion into the simulator, compiler, etc. (block 1238). One should note that, in some situations, the programmer may not desire to insert the assertion back into the program. More specifically, in some embodiments the programmer may determine that the assertion is correct, and thus does not need to be changed in the simulator. In these situations, the flowchart may not include this step.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. An assertion program for testing an assertion that is written for a logic program, wherein the logic program is configured for simulation in a simulation program, wherein the assertion program is distinct from the logic program and the assertion program is distinct from the simulation program, the assertion program comprising:
logic configured to determine at least one variable in the assertion;
logic configured to determine values for the at least one variable in the assertion;
logic configured to determine at least one of the values of the variable that corresponds to a violation of the assertion; and
logic configured to display the at least one determined value related to the violation of the assertion.

2. The assertion program of claim 1, wherein logic configured to determine at least one of the values of the variable that corresponds to a violation of the assertion includes logic configured to test all values of the at least one variable in the assertion.

3. The assertion program of claim 1, further comprising logic configured to display the at least one determined value related to the violation of the assertion as a graphical waveform.

4. The assertion program of claim 1, further comprising logic configured to receive the assertion from the simulation program.

5. The assertion program of claim 1, further comprising logic configured to facilitate insertion of the assertion into the logic program.

6. The assertion program of claim 1, wherein the assertion is written in at least one of the following languages: VHDL, Verilog, SVA, OVA, and PSL.

7. A method for testing an assertion written for a logic program that can be simulated in a simulation program, the method comprising:
receiving the assertion independent from the logic program and independent from the simulation program, wherein the assertion includes at least one variable from the simulation program;
determining the at least one variable in the assertion;
testing the assertion independent from the logic program and the simulation program, wherein testing the assertion includes testing the assertion with at least one value for the at least one variable; and
determining at least one violation of the assertion.

8. The method of claim 7, further comprising determining whether the assertion operates correctly.

9. The method of claim 7, further comprising facilitating insertion of the assertion into the logic program.

10. The method of claim 7, wherein the assertion is written in at least one of the following languages: VHDL, Verilog, SVA, OVA, and PSL.

11. The method of claim 7, wherein testing the assertion includes testing all values of the at least one variable in the assertion.

12. The method of claim 7, wherein the assertion includes a plurality of variables, wherein testing the assertion includes testing all permutations of values of the plurality of variables.

13. The method of claim 7, further comprising displaying at least one value associated with the determined at least one violation of the assertion.

14. A computer readable medium that includes an assertion program for testing an assertion written for a logic program, wherein the logic program can be executed in a simulation program, wherein the assertion program is different than the simulation program, and wherein the assertion program is different than the logic program, the assertion program comprising:
logic configured to receive the assertion independent from the logic program and independent from the simulation program, wherein the assertion includes at least one variable from the logic program;
logic configured to determine the at least one variable in the assertion;
logic configured to test the assertion independent from the logic program, wherein testing the assertion includes testing the assertion with at least one value for the at least one variable; and
logic configured to determine at least one violation of the assertion.

15. The computer readable medium of claim 14, the program further comprising logic configured to determine whether the assertion operates correctly.

16. The computer readable medium of claim 14, the program further comprising logic configured to facilitate insertion of the assertion into the logic program.

17. The computer readable medium of claim 14, wherein the assertion is written in at least one of the following languages: VHDL, Verilog, SVA, OVA, and PSL.

18. The computer readable medium of claim 14, wherein logic configured to test the assertion includes logic configured to test all values of the at least one variable in the assertion.

19. The computer readable medium of claim 14, wherein the assertion includes a plurality of variables, wherein logic configured to test the assertion includes logic configured to test all permutations of values of the plurality of variables.

20. The computer readable medium of claim 14, the program further comprising logic configured to display at least one value associated with the determined at least one violation of the assertion.
